(19) United States
(12) Patent Application Publication
(10) Pub. No.: US 2002/0046580 A1
(43) Pub. Date: Apr. 25, 2002

(54) Synthetic quartz glass article and process of production

(75) Inventors: Koji Matsuo, Nakakubiki-gun (JP); Motoyuki Yamada, Nakakubiki-gun (JP)

Correspondence Address: MILLEN, WHITE, ZELANO & BRANIGAN, P.C., 2200 CLARENDON BLVD., SUITE 1400, ARLINGTON, VA, 22201, US

(73) Assignee: Shin-Etsu Chemical Co., Ltd., Tokyo (JP)

(21) Appl. No.: 10/025,701

(22) Filed: Dec. 26, 2001

(30) Foreign Application Priority Data
Dec. 26, 2000 (JP) 2000-396151

(51) Int. Cl. C03C 21/00; C03B 37/018

(52) U.S. Cl. 65/397; 65/413

(57) ABSTRACT

A fluorine-containing synthetic quartz glass article is produced by feeding a silica-forming reactant gas, hydrogen gas, oxygen gas, and optionally, a fluorine compound gas from a burner to a reaction zone, flame hydrolyzing the silica-forming reactant gas in the reaction zone to form fine particles of silica, depositing the silica particles on a rotatable substrate in the reaction zone to form a porous silica matrix, heating and vitrifying the porous silica matrix in a fluorine compound gas-containing atmosphere to form a synthetic quartz glass ingot, removing a surface portion from the ingot, and heating and molding the surface-removed ingot. The article is optically homogeneous as demonstrated by a high transmittance to vacuum UV light of less than 200 nm like ArF or F₂ excimer laser light as well as a low birefringence and a small refractive index distribution.

### BACKGROUND OF THE INVENTION

1. Field of the Invention

The present invention relates to synthetic quartz glass articles suitable for lithography in a wavelength region of less than 400 nm, especially the vacuum ultraviolet region, and a process for producing the same.

2. Prior Art

Synthetic quartz glass having high UV transmittance plays the main role as optical members in the lithographic process for semiconductor manufacture.

The role of synthetic quartz glass in the lithographic system includes stepper lenses and reticle or photomask substrates which are used in the exposure and transfer steps of circuit patterns to silicon wafers.

The stepper apparatus generally includes an illumination section, a projection lens section and a wafer drive section. The illumination section converts light emitted by a light source into light of uniform intensity and guides it onto a reticle. The projection lens section plays the role of focusing the circuit pattern of the reticle onto a wafer in an accurate and reduced fashion. The materials of such components are required to be not only highly transmissive to light from the light source, but also optically homogeneous so that the transmitted light may have a uniform intensity.

As LSI chips continue to become more versatile and higher performing, research and development is actively underway to increase the level of device integration on wafers. Achieving higher device integration requires a high optical resolution capable of transferring very fine patterns. The resolution is represented by equation (1).

R=k₁×λ/NA (1)

R: resolution

k₁: coefficient

λ: wavelength of the light source

NA: numerical aperture

Equation (1) suggests that there are two ways for achieving a high resolution. One way is to increase the numerical aperture. Increasing the numerical aperture, however, entails a reduction of focal depth. The currently used numerical aperture is thus thought to be almost the limit. The other way is to shorten the wavelength of the light source. Today, the predominant ultraviolet radiation utilized as the light source has a wavelength of 248 nm (KrF excimer laser). Intensive efforts are being made to move on to shorter wavelength 198 nm (ArF excimer laser), and further reduction to wavelength 157 nm (F₂ excimer laser) is considered promising for the not-too-distant future.

As the material used in the wavelength region below 200 nm, known as the vacuum ultraviolet region, calcium fluoride single crystal is presumably employable if transmittance is the only consideration. However, many problems including material strength, a coefficient of thermal expansion, and surface polishing necessary to use as lenses must be overcome before the calcium fluoride single crystal can be used at the practical level. Therefore, synthetic quartz glass is expected to play the very important role as the stepper component material in the future.

Even for quartz glass having high UV transmittance, its transmittance gradually decreases in the vacuum UV region below 200 nm, and ceases altogether near 140 nm which is the absorption band attributable to the inherent structure of quartz glass.

The transmittance of quartz glass in the range to the inherent absorption region is determined by the type and concentration of defect structures in quart glass. With respect to the F₂ excimer laser having a light source wavelength of 157 nm, defect structures which affect transmittance include primarily Si—Si bonds and Si—OH bonds. Si—Si bonds, sometimes referred to as “oxygen deficiency defects,” have the central wavelength of absorption at 163 nm. Because these oxygen deficiency defects are also precursors of Si• defect structures (known as E′ centers) which have an absorption band at 215 nm, they cause serious problems not only when F₂ (157 nm) is used as the light source, but also on use of KrF (248 nm) or ArF (198 nm). Si—OH bonds exhibit an absorption band near 160 nm. Therefore, the formation of these defect structures must be minimized in order to produce quartz glass having a high transmittance in the vacuum UV region.

In the course of earlier research aimed at solving the above problem, quartz glass was produced by flame hydrolyzing a silica-forming reactant gas to form a porous silica matrix, then melting and vitrifying the porous silica matrix in a fluorine compound gas atmosphere. This method is successful in eliminating Si—OH bonds and instead, creating Si—F bonds in quartz glass. Si—F bonds are tenacious bonds with great bond energy, and have no absorption band at 150 to 170 nm. As a consequence, quartz glass doped with fluorine by the above method has high transmittance to vacuum UV radiation of F₂ excimer laser (157 nm).

Nevertheless, when the synthetic quartz glass thus obtained is shaped into substrates, there can often occur optical heterogeneity such as a distribution of transmittance in the substrate plane, a very high birefringence or the like. If optically heterogeneous substrates are used as the reticle, for example, images transferred therefrom are partially blurred. This inhibits the use of such materials as the reticle. It is thus desired to have a process of producing synthetic quartz glass having optical homogeneity as well as high transmittance.

### SUMMARY OF THE INVENTION

An object of the invention is to provide an optically homogeneous synthetic quartz glass article having a high transmittance to vacuum UV light below 200 nm, a low birefringence and a small refractive index distribution as well as a process for producing the synthetic quartz glass article.

We have found that by molding a vitrified synthetic quartz glass ingot after removing a surface portion thereof, there is obtained an optically homogeneous synthetic quartz glass article having a high transmittance to vacuum UV light below 200 nm as emitted by an ArF or F₂ excimer laser, a low birefringence and a small refractive index distribution.

According to the invention, there is provided a process for producing a fluorine-containing synthetic quartz glass article, comprising the steps of feeding a silica-forming reactant gas, hydrogen gas, oxygen gas, and optionally, a fluorine compound gas from a burner to a reaction zone, flame hydrolyzing the silica-forming reactant gas in the reaction zone to form fine particles of silica, depositing the silica particles on a rotatable substrate in the reaction zone to form a porous silica matrix, heating and vitrifying the porous silica matrix in a fluorine compound gas-containing atmosphere to form a synthetic quartz glass ingot, and heating and molding the ingot into a synthetic quartz glass article. A surface portion of the synthetic quartz glass ingot should be removed prior to the heating and molding step.

The ingot has a diameter defining an outer periphery and a length between longitudinal opposite ends, and in a preferred embodiment, the surface portion of the synthetic quartz glass ingot which is removed is up to 50% of the diameter of the ingot at the outer periphery and up to 50% of the length, in total, at the opposite ends.

Also contemplated herein is a synthetic quartz glass article obtained by the above process. It should preferably have a birefringence of up to 10 nm/cm; a refractive index distribution of up to 5×10⁻⁴; a minimum transmittance of at least 80.0% to light having a wavelength of 157.6 nm; a transmittance distribution of up to 1.0% to light having a wavelength of 157.6 nm; a minimum transmittance of at least 90.0% to light having a wavelength of 193.4 nm; and/or a transmittance distribution of up to 1.0% to light having a wavelength of 193.4 nm.

### BRIEF DESCRIPTION OF THE DRAWING

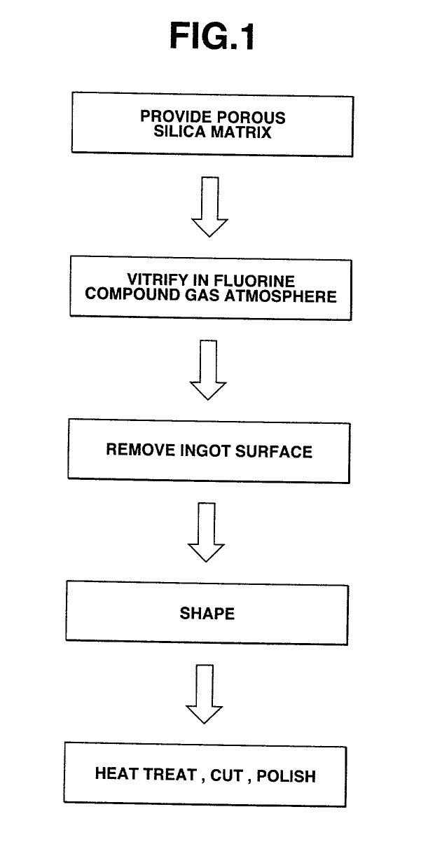

The only figure, FIG. 1 is a block flow diagram of the process for producing a synthetic quartz glass article according to the invention.

### DESCRIPTION OF THE PREFERRED EMBODIMENT

The invention is directed to a fluorine-containing synthetic quartz glass article having a high transmittance to vacuum UV radiation and optical homogeneity and a process for producing the same.

To increase the transmittance of quartz glass to vacuum UV radiation, quartz glass must be doped with fluorine atoms to create Si—F bonds in the glass structure. This is because the creation of Si—F bonds, in turn, reduces the number of Si—Si bonds and Si—OH bonds capable of absorbing vacuum UV radiation. In addition, Si—F bonds are highly resistant to UV radiation on account of their substantial bond energy.

The process for producing a fluorine-containing synthetic quartz glass article according to the invention is illustrated in the block flow diagram of FIG. 1. A first step is to provide a porous silica matrix. A second step is to vitrify the porous silica matrix in a fluorine compound gas atmosphere into a quartz glass ingot. A third step is to remove a surface portion, specifically peripheral and end portions, of the quartz glass ingot by grinding and/or cutting. A fourth step is to shape the surface-removed ingot. A fifth step is a finish treatment including heat treatment, cutting and polishing. As opposed to the prior art process where the vitrified ingot directly proceeds to the molding step, the present invention involves the step of removing a surface portion of the ingot as by grinding or cutting prior to the molding step.

The respective steps are described in detail.

The first step of providing a porous silica matrix involves feeding a silica-forming reactant gas, hydrogen gas, and oxygen gas or a silica-forming reactant gas, hydrogen gas, oxygen gas and a fluorine compound gas from a burner to a reaction zone, flame hydrolyzing the silica-forming reactant gas in the reaction zone to form fine particles of silica, and depositing the silica particles on a rotatable substrate in the reaction zone to form a porous silica matrix. In the second step, the porous silica matrix is heated and vitrified in a fluorine compound gas-containing atmosphere to form a synthetic quartz glass ingot. The process to this stage is per se known and may be carried out under known conditions. For example, the flow rates of oxygen gas, hydrogen gas, silica-forming reactant gas and fluorine compound gas are selected in conventional flow rate ranges.

The silica-forming reactant used herein may be selected from well-known silicon compounds including chlorosilanes such as silicon tetrachloride, alkoxysilanes such as tetramethoxysilane and siloxanes such as hexamethyldisiloxane. Of these, the alkoxysilanes free of chlorine are preferred because Si—Cl bonds absorb UV radiation. The fluorine compound may be selected from SiF₄, CHF₃, and CF₄, to name a few.

The porous silica matrix resulting from flame hydrolysis reaction is then heated for vitrification in a furnace having an atmosphere of the fluorine compound gas, or an inert gas (e.g., helium or argon) or a mixture thereof. The vitrifying temperature is preferably in the range of 1,200° C. to 1,700° C. although appropriate vitrifying temperature and time depend on the concentration of fluorine compound gas in the vitrifying atmosphere, the density of the porous silica matrix and other factors. Following vitrification, the quartz glass is cooled to room temperature within the same furnace by quenching, controlled slow cooling or allowing to cool.

The synthetic quartz glass thus obtained preferably has a fluorine content of 0.01 to 2.4% by weight, and especially 0.1 to 1.5% by weight at the center thereof.

The synthetic quartz glass thus obtained is shaped and further processed as by heat treatment, cutting and polishing, into an optical article suitable for lithography. When substrates are produced in this way according to the prior art process, many of the substrates are optically heterogeneous as demonstrated by a distribution of transmittance or refractive index within the substrate plane and a substantial birefringence. Optical heterogeneity is apt to occur upon vitrification of the porous silica matrix. As quartz glass is doped with fluorine in the course of vitrification, the fluorine doping takes place from the outer periphery of the matrix. This invites a differential fluorine concentration between the interior and the outer periphery of the ingot at the end of vitrification. Opposite ends of the matrix correspond to the start and end of growth of the matrix and tend to have a density difference from a straight barrel portion relying on continuous growth. Such a difference of matrix density often inhibits uniform fluorine doping even when vitrification is carried out under the same conditions.

As a result, the ingot as vitrified has a distribution of fluorine concentration. Direct molding and annealing of this ingot almost fails to produce an optically homogeneous article.

If the fluorine concentration of quartz glass differs, the strain point and annealing point thereof also differ. Then a single ingot includes portions which are effectively annealed and portions which are not effectively annealed under preset annealing conditions, and even portions which become more heterogeneous by annealing. This is the reason why the substrates produced by the prior art process are optically heterogeneous.

With this taken into account, we have discovered that if a surface portion of the ingot which has a fluorine concentration largely different from that of the central portion of the ingot is removed from the ingot, this surface-removed ingot to be shaped has a minimized distribution of fluorine concentration so that the effect of annealing is exerted throughout the ingot.

The removal of the surface portion is also advantageous since the birefringence of the ingot is smaller in proximity to the center.

The technique of removing a surface portion of the synthetic quartz glass ingot prior to molding may be grinding, cutting or the like. It is noted that the ingot has a diameter defining the outer periphery and a length between longitudinal opposite ends corresponding to the start and end of growth of the matrix. In one preferred embodiment, the surface portion of the synthetic quartz glass ingot which is removed at the outer periphery is up to 50%, preferably up to 30%, and more preferably up to 10% of the ingot diameter. Similarly, the surface portion of the ingot which is removed at the opposite ends is up to 50%, preferably up to 30%, and more preferably up to 10% of the ingot length, provided that the cut distances at the opposite ends are combined. Understandably, the extent of the surface portion of the synthetic quartz glass ingot which is removed is preferably selected so that the desired birefringence, refractive index distribution, transmittance and transmittance distribution to be described below may be accomplished. The cut distances at opposite ends are properly selected in accordance with a particular purpose and can be equal, for example, though not limited thereto.

The synthetic quartz glass ingot ground and cut in this way is then shaped in an electric or similar furnace and then processed through steps of heat treatment, cutting and polishing into an optical article for lithographic use.

The synthetic quartz glass article produced by the inventive process finds use as lenses, substrates and blanks, while it preferably has physical properties as discussed below.

Birefringence is measured by optical heterodyne detection using a He—Ne laser of 633 nm wavelength, and its value is preferably up to 10 nm/cm, more preferably up to 5 nm/cm, and even more preferably up to 1 nm/cm. It is noted that since the birefringence is dependent on wavelength, the birefringence at the actual wavelength of 157.6 nm and 193.4 nm is calculated by conversion from the measurement at the wavelength of 633 nm (see Physics and Chemistry of Glasses 19 (4), 1978).

The distribution of refractive index is measured by optical interferometry using a He—Ne laser of 633 nm wavelength, and its value is preferably up to 5×10⁻⁴, more preferably up to 1×10⁻⁴, and even more preferably up to 1×10⁻⁵.

Transmittance is measured by a spectrophotometer. At the wavelength of 157.6 nm, the minimum transmittance is preferably at least 80.0%, more preferably at least 83.0%, and even more preferably at least 84.0%. At the wavelength of 193.4 nm, the minimum transmittance is preferably at least 90.0%, more preferably at least 90.4%, and even more preferably at least 90.6%.

The distribution of transmittance at the wavelength of 157.6 nm is up to 1.0%, more preferably up to 0.5%, and even more preferably up to 0.3%. The distribution of transmittance at the wavelength of 193.4 nm is up to 1.0%, more preferably up to 0.5%, and even more preferably up to 0.2%.

### EXAMPLE

Examples of the invention and comparative examples are given below by way of illustration, and not by way of limitation. The parameters used in the examples are not intended to restrict the scope of the invention.

### Example 1

A porous silica matrix was produced by feeding from a burner hydrogen gas, oxygen gas, and tetramethoxysilane gas as the silica-forming reactant, and carrying out hydrolysis in an oxyhydrogen flame. The matrix was heated to 1,500° C. in an atmosphere of SiF₄ and He mixture, forming a cylindrical synthetic quartz glass ingot.

The outer periphery of the ingot was removed by cylindrical grinding in an amount of 25% of the outer diameter, and the opposite ends of the ingot were removed each in an amount of 10% of the longitudinal length, and 20% in total. The ingot whose peripheral and end portions had been removed was shaped in an electric furnace, finally obtaining a substrate of 152.4 mm square and 6.35 mm thick.

The substrate had a transmittance as measured at 157.6 nm of 84.0 to 84.5% within the substrate plane. The transmittance measured at 193.4 nm was 90.60 to 90.75% within the substrate plane. The birefringence was 3 nm/cm. The refractive index distribution was 1×10⁻⁴.

### Example 2

A porous silica matrix was produced by feeding from a burner hydrogen gas, oxygen gas, and tetramethoxysilane gas as the silica-forming reactant, and carrying out hydrolysis in an oxyhydrogen flame. The matrix was heated to 1,500° C. in an atmosphere of SiF₄ and He mixture, forming a cylindrical synthetic quartz glass ingot.

The outer periphery of the ingot was removed by cylindrical grinding in an amount of 5% of the outer diameter, and the opposite ends of the ingot were removed each in an amount of 2.5% of the longitudinal length, and 5% in total. The ingot whose peripheral and end portions had been removed was shaped in an electric furnace, finally obtaining a substrate of 152.4 mm square and 6.35 mm thick.

The substrate had a transmittance as measured at 157.6 nm of 83.5 to 84.5% within the substrate plane. The transmittance measured at 193.4 nm was 90.50 to 90.70% within the substrate plane. The birefringence was 10 nm/cm. The refractive index distribution was 3×10⁻⁴.

### Example 3

A porous fluorine-containing silica matrix was produced by feeding from a burner hydrogen gas, oxygen gas, tetramethoxysilane gas as the silica-forming reactant, and SiF₄ gas, and carrying out hydrolysis in an oxyhydrogen flame. The matrix was heated to 1,500° C. in an atmosphere of SiF₄ and He mixture, forming a cylindrical synthetic quartz glass ingot.

The outer periphery of the ingot was removed by cylindrical grinding in an amount of 10% of the outer diameter, and the opposite ends of the ingot were removed each in an amount of 5% of the longitudinal length, and 10% in total. The ingot whose peripheral and end portions had been removed was shaped in an electric furnace, finally obtaining a substrate of 152.4 mm square and 6.35 mm thick.

The substrate had a transmittance as measured at 157.6 nm of 84.2 to 84.9% within the substrate plane. The transmittance measured at 193.4 nm was 90.55 to 90.75% within the substrate plane. The birefringence was 7 nm/cm. The refractive index distribution was 2×10⁻⁴.

### Comparative Example 1

A porous silica matrix was produced by feeding from a burner hydrogen gas, oxygen gas, and tetramethoxysilane gas as the silica-forming reactant, and carrying out hydrolysis in an oxyhydrogen flame. The matrix was heated to 1,500° C. in an atmosphere of SiF₄ and He mixture, forming a cylindrical synthetic quartz glass ingot.

The ingot was shaped in an electric furnace without grinding and cutting. There was obtained a substrate of 152.4 mm square and 6.35 mm thick.

The substrate had a transmittance as measured at 157.6 nm of 75.0 to 83.5% within the substrate plane. The transmittance measured at 193.4 nm was 89.50 to 90.70% within the substrate plane. The birefringence was 65 nm/cm. The refractive index distribution was 8×10⁻⁴.

There has been described a process involving the steps of removing a surface portion from a synthetic quartz glass ingot as vitrified, and then molding the surface-removed ingot. An optically homogeneous synthetic quartz glass article is produced having a high transmittance to vacuum UV radiation below 200 nm like ArF or F₂ excimer laser light as well as a low birefringence, and a small refractive index distribution.

Japanese Patent Application No. 2000-396151 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A process for producing a fluorine-containing synthetic quartz glass article, comprising the steps of feeding a silica-forming reactant gas, hydrogen gas, oxygen gas, and optionally, a fluorine compound gas from a burner to a reaction zone, flame hydrolyzing the silica-forming reactant gas in the reaction zone to form fine particles of silica, depositing the silica particles on a rotatable substrate in the reaction zone to form a porous silica matrix, heating and vitrifying the porous silica matrix in a fluorine compound gas-containing atmosphere to form a synthetic quartz glass ingot, and heating and molding the ingot into a synthetic quartz glass article, characterized in that a surface portion of the synthetic quartz glass ingot is removed prior to the heating and molding step.

2. The process of claim 1 wherein the ingot has a diameter defining an outer periphery and a length between longitudinal opposite ends, and the surface portion of the synthetic quartz glass ingot which is removed is up to 50% of the diameter of the ingot at the outer periphery and up to 50% of the length, in total, at the opposite ends.

3. A synthetic quartz glass article obtained by the process of claim 1.

4. The synthetic quartz glass article of claim 3, having a birefringence of up to 10 nm/cm.

5. The synthetic quartz glass article of claim 3, having a refractive index distribution of up to 5×10⁻⁴.

6. The synthetic quartz glass article of claim 3, having a minimum transmittance of at least 80.0% to light having a wavelength of 157.6 nm.

7. The synthetic quartz glass article of claim 3, having a transmittance distribution of up to 1.0% to light having a wavelength of 157.6 nm.

8. The synthetic quartz glass article of claim 3, having a minimum transmittance of at least 90.0% to light having a wavelength of 193.4 nm.

9. The synthetic quartz glass article of claim 3, having a transmittance distribution of up to 1.0% to light having a wavelength of 193.4 nm.
